(19) United States
(12) Patent Application Publication
(10) Pub. No.: US 2016/0122222 A1
(43) Pub. Date: May 5, 2016

(54) FEEDER

(71) Applicant: NIPPON ELECTRIC GLASS CO., LTD., Otsu-shi, Shiga (JP)

(72) Inventors: Tsunetaka KISHI, Shiga (JP); Hiroshi UENISHI, Shiga (JP)

(21) Appl. No.: 14/889,944

(22) PCT Filed: Mar. 7, 2014
(86) PCT No.: PCT/JP2014/056053

§ 371 Date: Nov. 9, 2015

(30) Foreign Application Priority Data
May 14, 2013 (JP) 2013-102182

(51) Int. Cl. C03B 7/07; C03B 37/02

(52) U.S. Cl. CPC C03B 7/07; C03B 37/02

(57) ABSTRACT

Provided is a feeder (3) configured such that molten glass (G) is caused to flow through an inside of the feeder (3), the feeder (3) including: electric heating elements (6) arranged in an internal space (S) of the feeder (3) along a flowing direction of the molten glass (G), which are configured to heat the molten glass (G); and restricting portions (7) provided in a heat transfer path in which heat from the electric heating elements (6) reaches a surface (Ga) of the molten glass, which are configured to restrict the heat from being directly transferred to the molten glass (G).

### TECHNICAL FIELD

The present invention relates to a feeder configured such that molten glass is caused to flow through an inside thereof.

### BACKGROUND ART

For example, when molten glass is supplied to bushings configured to form glass fibers, a forming trough configured to form a glass sheet, or the like, it is required to maintain a temperature of the molten glass flowing through an inside of a feeder, to thereby prevent the temperature from being lowered. As a method to meet such a requirement, there is widely adopted a method involving arranging burners for burning a mixture of fuel such as natural gas and air (oxygen) in an internal space of the feeder so that the molten glass is heated by the heat from the burners (refer to Patent Literature 1).

Incidentally, when this method is adopted, the following inconveniences occur. (1) Environmentally hazardous substances contained in the molten glass, such as boron oxide (B₂O₃), are volatilized by the heat from the burners and discharged through a flue formed in the feeder. (2) Sealability of the feeder is low and temperature-maintaining property is poor due to the presence of the flue. (3) An oxidation-reduction atmosphere in the internal space is liable to be fluctuated and reboil bubbles are liable to be generated in the molten glass depending on a burning state of the burners. (4) When dust contained in the flue gas falls on the molten glass, the dust may cause foreign matters to be generated in the glass.

In view of the above, as a method to eliminate those inconveniences, there may be adopted a method involving arranging electric heating elements, instead of the burners, along a flowing direction of the molten glass in the internal space of the feeder so that the molten glass is heated by the heat from the electric heating elements. In this way, the flue gas is not generated in the internal space, and hence the flue is not required to be formed in the feeder. Moreover, the heat is generated through electricity, and hence the oxidation-reduction atmosphere in the internal space is less liable to be fluctuated. For such reasons, the above-mentioned inconveniences (1) to (4) can be suitably eliminated.

### CITATION LIST

Patent Literature 1: JP 2010-513183 A

### SUMMARY OF INVENTION

### Technical Problem

However, even when the methods described above are adopted, there still remain the following problems to be solved. Specifically, transferability of the heat of the molten glass flowing through the inside of the feeder differs depending on a distance from the electric heating elements. The molten glass flowing nearer to the electric heating elements is more easily heated. Therefore, it is difficult to heat the entire molten glass uniformly, for example, due to a temperature difference between the molten glass flowing nearer to the electric heating elements and the molten glass flowing farther therefrom.

Further, for example, when the molten glass having non-uniform temperature distribution as described above is supplied to the bushings so that the glass fibers are formed, a viscosity difference in the molten glass flowing downward through bushing nozzles causes a situation where smooth formation of the fibers is inhibited, for example, a situation where the fibers are broken due to fluctuation in fiber diameter.

Further, the non-uniform temperature distribution in the molten glass has an adverse effect not only when the glass fibers are formed by the bushings but also when a glass article such as a glass sheet is formed by supplying the molten glass to the forming trough. Therefore, the temperature distribution in the molten glass supplied to the bushings, the forming trough, or the like, and further, the temperature distribution in the molten glass flowing through the inside of the feeder are required to be kept uniform. Therefore, development of a technology to meet such a requirement is desired.

The present invention has been made in view of the above-mentioned circumstances, and has a technical object to keep uniform temperature distribution in molten glass flowing through an inside of a feeder.

### Solution to Problem

According to one embodiment of the present invention, which has been devised to achieve the above-mentioned object, there is provided a feeder configured such that molten glass is caused to flow through an inside of the feeder, the feeder comprising: electric heating elements arranged in an internal space of the feeder along a flowing direction of the molten glass, which are configured to heat the molten glass; and restricting portions provided in a heat transfer path in which heat from the electric heating elements reaches a surface of the molten glass, which are configured to restrict the heat from being directly transferred to the molten glass.

With such a configuration, the heat is restricted from being directly transferred from the electric heating elements to the molten glass. The heat from the electric heating elements is transferred to the molten glass through a heat transfer path in which the heat bypasses the restricting portions to reach the surface of the molten glass, and through a heat transfer path in which the heat from the electric heating elements heats the restricting portions and then the heat from the restricting portions reaches the surface of the molten glass. In this manner, the molten glass flowing nearer to the electric heating elements and the molten glass flowing farther therefrom can be heated evenly and uniformly, and hence the temperature difference therebetween can be suppressed to the extent possible. As a result, the temperature distribution in the molten glass flowing through the inside of the feeder can be kept uniform.

In the above-mentioned configuration, it is preferred that the restricting portions comprise plate-like members interposed between the electric heating elements and the surface of the molten glass.

In this way, the heat from the electric heating elements is reliably restricted from being directly transferred to the molten glass. Therefore, the molten glass flowing nearer to the electric heating elements and the molten glass flowing farther therefrom can be heated more uniformly. Moreover, the plate-like members are interposed, and hence an alkaline component or the like volatilized from the molten glass becomes less liable to adhere to the electric heating elements. Therefore, a situation where the electric heating elements are corroded can be suppressed.

In the above-mentioned configuration, it is preferred that the electric heating elements be arranged on lateral sides in the internal space of the feeder in a width direction of the internal space, and that the plate-like members extend from side portions of an inner peripheral wall of the feeder toward a center in the width direction of the internal space along a bottom portion of the inner peripheral wall of the feeder.

In this way, a part of the heat from the electric heating elements, which bypasses the plate-like members to reach the surface of the molten glass, is transferred to the molten glass via the center in the width direction. In this heat transfer path, the heat passes through a broad region in the internal space of the feeder. Therefore, the molten glass flowing nearer to the electric heating elements and the molten glass flowing farther therefrom can be heated more uniformly. Further, even when a part of the heating elements is fractured due to corrosion of the heating elements and the like, the fractured portion falls on the plate-like members so that the fractured portion can be prevented from falling on the molten glass. As a result, a situation where a defect is generated in glass products manufactured of the molten glass, which is caused by the falling of the fractured portion, can be avoided to the extent possible.

In the above-mentioned configuration, the feeder may further comprise bushings provided in the bottom portion of the inner peripheral wall of the feeder, which are configured to form the molten glass into glass fibers.

When the glass fibers are formed, the feeder generally comprises a large number of the bushings provided in the bottom portion of the feeder configured to supply the molten glass along the flowing direction of the molten glass. Therefore, the feeder is liable to be large and long, which causes difficulty in uniformly maintaining the temperature distribution in the molten glass. Further, a fiber diameter of the glass fiber ranges from several micrometers to several tens of micrometers, and hence the glass fiber is significantly thin. Therefore, when the temperature distribution in the molten glass is non-uniform, the fibers are liable to be broken due to the fluctuation in fiber diameter. However, according to the one embodiment of the present invention, in any portion in such a large and long feeder, the temperature distribution in the molten glass flowing through the inside thereof can be kept uniform, thereby being capable of forming the glass fibers with high quality.

### Advantageous Effects of Invention

As described above, according to the one embodiment of the present invention, it is possible to keep uniform temperature distribution in the molten glass flowing through the inside of the feeder.

### BRIEF DESCRIPTION OF DRAWINGS

FIG. 1 is a vertical cross-sectional side view for schematically illustrating a glass fiber manufacturing apparatus comprising a feeder according to a first embodiment of the present invention.

FIG. 2 is a vertical cross-sectional front cross-section taken along the line A-A of FIG. 1, for illustrating the feeder according to the first embodiment of the present invention.

FIG. 3 is a vertical cross-sectional front cross-section for illustrating a feeder according to a second embodiment of the present invention.

FIG. 4 is a vertical cross-sectional front cross-section for illustrating a feeder according to a third embodiment of the present invention.

FIG. 5a is a vertical cross-sectional front cross-section for illustrating a feeder according to a fourth embodiment of the present invention.

FIG. 5b is a vertical cross-sectional front view for illustrating a feeder according to a fifth embodiment of the present invention.

FIG. 5c is a vertical cross-sectional front view for illustrating a feeder according to a sixth embodiment of the present invention.

FIG. 6 is a vertical cross-sectional front cross-section for illustrating a feeder according to a seventh embodiment of the present invention.

FIG. 7 is a vertical cross-sectional front cross-section for illustrating a feeder according to an eighth embodiment of the present invention.

### DESCRIPTION OF EMBODIMENTS

Now, embodiments of the present invention are described referring to the accompanying drawings.

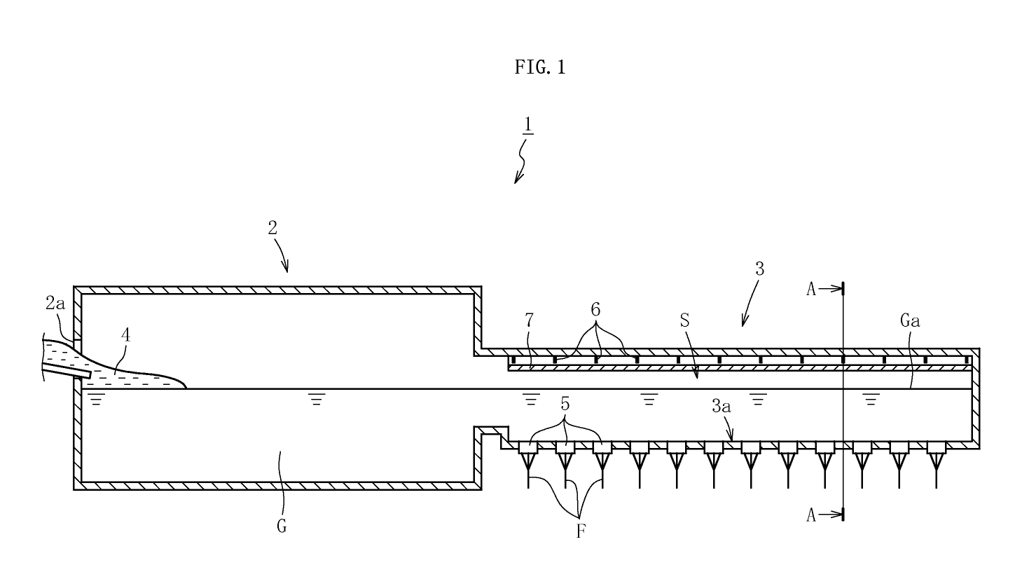

FIG. 1 is a vertical cross-sectional side view for schematically illustrating a glass fiber manufacturing apparatus comprising a feeder according to a first embodiment of the present invention. As illustrated in FIG. 1, a glass fiber manufacturing apparatus 1 comprises a melting furnace 2 and a feeder 3 as main components thereof. The melting furnace 2 heats a glass raw material 4 fed into the furnace from an upstream end portion thereof and generates molten glass G by continuously melting the glass raw material 4. The feeder 3 is connected to a downstream side of the melting furnace 2 and supplies the generated molten glass G to a large number of bushings 5 configured to form glass fibers.

A furnace wall of the melting furnace 2 is formed of a refractory (for example, bricks). Further, in the upstream end portion, the melting furnace 2 comprises a feed port 2a through which the glass raw material 4, which is obtained by mixing silica sand, limestone, soda ash, cullet, and the like, is fed into the furnace. Further, the melting furnace 2 heats the glass raw material 4 fed through the feed port 2a with use of heating means (for example, an electric heater) (not shown), to thereby continuously generate the molten glass G and cause the generated molten glass G to flow out toward the downstream side.

A peripheral wall of the feeder 3 is formed of a refractory. Further, the feeder 3 is connected to the downstream side of the melting furnace 2. The feeder 3 comprises, in a bottom portion 3a, the large number of bushings 5 configured to form the glass fibers along a flowing direction of the molten glass G. The bushings 5 are each formed of platinum or an alloy thereof. Further, a plurality of bushing nozzles are formed in the bushings 5, respectively. The molten glass G flows downward through the respective nozzles to be formed into glass fibers F. Note that, the molten glass G flowing downward through the respective nozzles is formed into the glass fibers F (glass filaments) having a predetermined diameter while being drawn downward. Further, a plurality of the glass fibers F are bundled into a glass strand through application of binder.

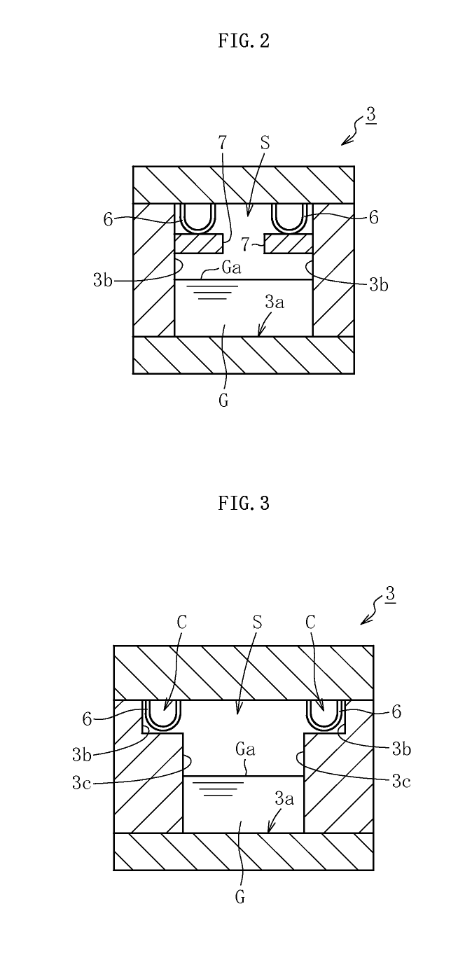

Further, as illustrated in FIG. 2 (cross-section taken along the line A-A of FIG. 1), the feeder 3 has a rectangular shape in horizontal cross-section, and has formed therein an internal space S surrounded by an inner peripheral wall of the feeder 3 and a surface Ga of the molten glass. In the internal space S, a pair of electric heating elements 6 and a pair of refractory plates 7 are provided. The pair of electric heating elements 6 heats the molten glass G to maintain a temperature thereof. The pair of refractory plates 7 is formed of a refractory and interposed between the electric heating elements 6 and the surface Ga of the molten glass.

Assuming that the pair of electric heating elements 6 present on symmetrical both lateral sides with respect to a center of the internal space S in a width direction (lateral direction of FIG. 2) is one set, a plurality of sets of the electric heating elements 6 are arranged along the flowing direction of the molten glass G (longitudinal direction of the feeder 3) at equal intervals. Further, each of the electric heating elements 6 is formed into a U-like shape in horizontal cross-section and mounted to an upper portion of the inner peripheral wall of the feeder 3 to be connected to an electrode (not shown). Each of the electric heating elements 6 generates heat through energization, thereby maintaining the temperature of the molten glass G. Note that, the plurality of sets of the electric heating elements 6 may be controlled by a single electric circuit.

Each of the pair of refractory plates 7 has a rectangular shape, and is mounted to the inner peripheral wall of the feeder 3 along the flowing direction of the molten glass G. Each of the pair of refractory plates 7 extends from a side portion 3b of the inner peripheral wall horizontally toward the center in the width direction along a bottom portion 3a and the surface Ga of the molten glass. Further, similarly to the electric heating elements 6, both the refractory plates 7 are present at symmetrical positions with respect to the center in the width direction. Further, the refractory plates 7 restrict the heat from being directly transferred to the molten glass G in a heat transfer path in which the heat from the electric heating elements 6 reaches the surface Ga of the molten glass. Specifically, in this embodiment, the refractory plates 7 serve as restricting portions (plate-like members).

Now, operations and effects obtained when the glass fibers are formed through use of the above-mentioned glass fiber manufacturing apparatus 1 are described.

According to the above-mentioned glass fiber manufacturing apparatus 1, in the internal space S of the feeder 3, the heat is reliably restricted from being directly transferred to the molten glass G by the refractory plates 7. The heat from the electric heating elements 6 is transferred to the molten glass G through a heat transfer path in which the heat bypasses the refractory plates 7 to reach the surface Ga of the molten glass via the center in the width direction, and through a heat transfer path in which the heat from the electric heating elements 6 heats the refractory plates 7 and then the heat from the refractory plates 7 reaches the surface Ga of the molten glass.

In this manner, the molten glass G flowing nearer to the electric heating elements 6 and the molten glass G flowing farther therefrom can be heated evenly and uniformly, and hence a temperature difference therebetween can be suppressed to the extent possible. Therefore, temperature distribution in the molten glass G flowing through the inside of the feeder 3 can be kept uniform.

As a result, in any portion in the large and long feeder 3 comprising the large number of bushings 5 in the bottom portion 3a, the temperature distribution in the molten glass G flowing through the inside thereof is stabilized and kept uniform, thereby being capable of forming the glass fibers F with high quality.

Moreover, the refractory plates 7 are interposed between the electric heating elements 6 and the surface Ga of the molten glass, and hence an alkaline component or the like volatilized from the molten glass G becomes less liable to adhere to the electric heating elements 6. Therefore, a situation where the heating elements 6 are corroded can be suppressed.

In addition, even when a part of the heating elements 6 is fractured due to the corrosion of the electric heating elements 6 and the like, the fractured portion falls on the refractory plates 7 so that the fractured portion can be prevented from falling on the molten glass G. As a result, a situation where a defect is generated in the glass fibers F formed of the molten glass G, which is caused by the falling of the fractured portion, can be avoided to the extent possible.

Now, feeders according to other embodiments of the present invention are described. Note that, in the feeders according to the other embodiments, components having the same function or shape as those of the feeder according to the above-mentioned first embodiment are denoted by the same reference symbols in the drawings for illustrating the respective embodiments, and a redundant description thereof is therefore omitted.

FIG. 3 is a vertical cross-sectional front cross-section for illustrating a feeder according to a second embodiment of the present invention. The feeder 3 according to the second embodiment is different from the feeder according to the first embodiment in that the refractory plates 7 are removed, that bank portions 3c are formed in the side portions 3b of the inner peripheral wall of the feeder 3, and that recessed portions C for receiving the electric heating elements 6 are formed above the bank portions 3c.

The side portions 3b of the inner peripheral wall partially project toward the center in the width direction so that the projecting portions form the bank portions 3c. A projecting dimension of the bank portions 3c is set to be larger than a dimension of the electric heating elements 6 in the width direction so that the heating elements 6 are entirely received in the recessed portions C. Further, the bank portions 3c restrict the heat from being directly transferred to the molten glass G in the heat transfer path in which the heat from the electric heating elements 6 reaches the surface Ga of the molten glass. Specifically, in this embodiment, the bank portions 3c serve as the restricting portions.

Also in the feeder 3 according to the second embodiment, similar effects as those of the feeder according to the above-mentioned first embodiment can be provided. Note that, in the second embodiment, the heat is reliably restricted from being directly transferred to the molten glass G by the bank portions 3c. The heat from the electric heating elements 6 is transferred to the molten glass G through a heat transfer path in which the heat bypasses the bank portions 3c to reach the surface Ga of the molten glass, and through a heat transfer path in which the heat from the electric heating elements 6 heats the bank portions 3c and then the heat from the bank portions 3c reaches the surface Ga of the molten glass.

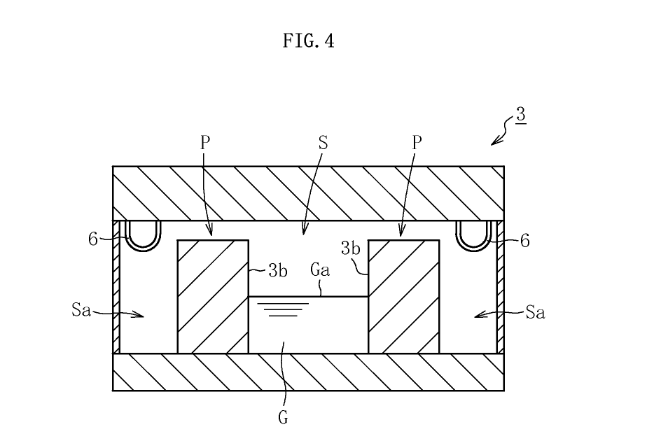

FIG. 4 is a vertical cross-sectional front cross-section for illustrating a feeder according to a third embodiment of the present invention. The feeder 3 according to the third embodiment is different from the feeder according to the first embodiment in that the refractory plates 7 are removed, that passages P are formed between the upper portions of the inner peripheral wall of the feeder 3 and the side portions 3b, and that extended spaces Sa are formed by extending the internal space S to an outer side of the side walls 3b in the width direction through the passages P.

The extended space Sa is formed along the flowing direction of the molten glass G, and the electric heating elements 6 are received in upper portions thereof. Further, the side portions 3b of the inner peripheral wall of the feeder 3 are interposed between the heating elements 6 and the surface Ga of the molten glass, and hence the heat is restricted from being directly transferred to the molten glass G in the heat transfer path in which the heat from the electric heating elements 6 reaches the surface Ga of the molten glass. Specifically, in this embodiment, the side portions 3b serve as the restricting portions (plate-like members).

Also in the feeder 3 according to the third embodiment, similar effects as those of the feeder according to the above-mentioned first embodiment can be provided. Note that, in the third embodiment, the heat is reliably restricted from being directly transferred to the molten glass G by the side portions 3b. The heat from the electric heating elements 6 is transferred to the molten glass G through a heat transfer path in which the heat bypasses the side portions 3b and passes through the passages P to reach the surface Ga of the molten glass, and through a heat transfer path in which the heat from the electric heating elements 6 heats the side portions 3b and then the heat from the side portions 3b reaches the surface Ga of the molten glass.

In addition, in the third embodiment, even when a part of the heating elements 6 is fractured due to the corrosion of the electric heating elements 6 and the like, the fractured portion falls on bottom portions of the extended spaces Sa isolated from the molten glass G so that the fractured portion can be substantially reliably prevented from falling on the molten glass G. Therefore, there is an advantage in that the generation of a defect is avoided in the glass fibers F manufactured of the molten glass G.

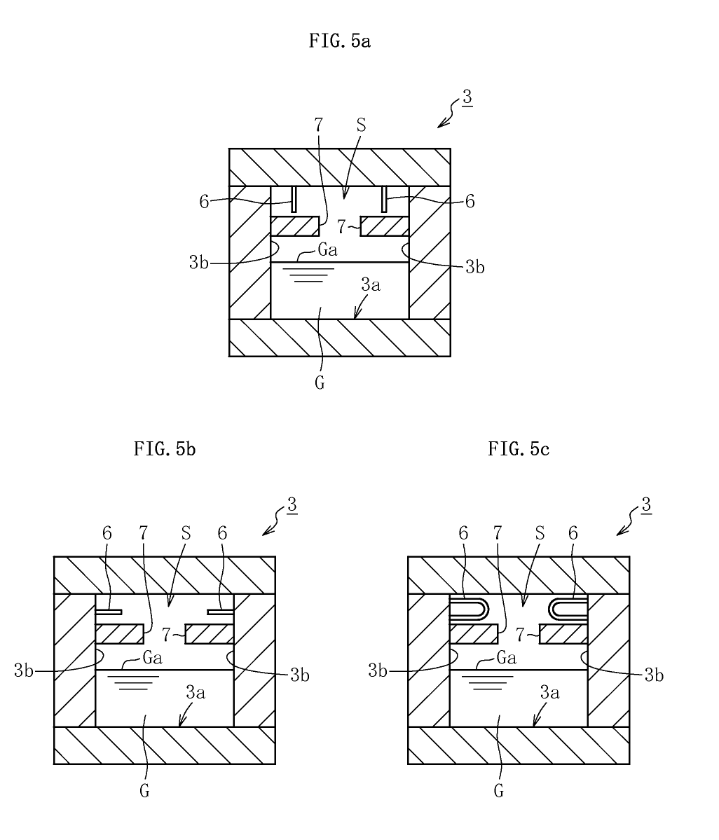

FIG. 5a to FIG. 5c are vertical cross-sectional front cross-sections for respectively illustrating feeders according to a fourth embodiment to a sixth embodiment of the present invention. In those feeders 3, shapes and mounting positions of the electric heating elements are changed from those of the feeder according to the above-mentioned first embodiment.

In the feeder 3 according to the fourth embodiment illustrated in FIG. 5a, the shapes of the electric heating elements 6 are changed from the U-like shapes to bar-like shapes. In the feeder 3 according to the fifth embodiment illustrated in FIG. 5b, the shapes of the electric heating elements 6 are changed to bar-like shapes, and the mounting positions are changed from the upper portions to the side portions 3b of the inner peripheral wall of the feeder 3. In the feeder 3 according to the sixth embodiment illustrated in FIG. 5c, the mounting positions of the electric heating elements 6 each having a U-like shape are changed from the upper portions to the side portions 3b of the inner peripheral wall of the feeder 3.

Also in the feeder 3 according to the fourth embodiment to the sixth embodiment, similar effects as those of the feeder according to the above-mentioned first embodiment can be provided. Further, those feeders 3 according to the fourth embodiment to the sixth embodiment are similar to the feeder according to the first embodiment also in the heat transfer path in which the heat from the electric heating elements 6 is transferred to the molten glass G, and in the refractory plates 7 serving as the restricting portions (plate-like members).

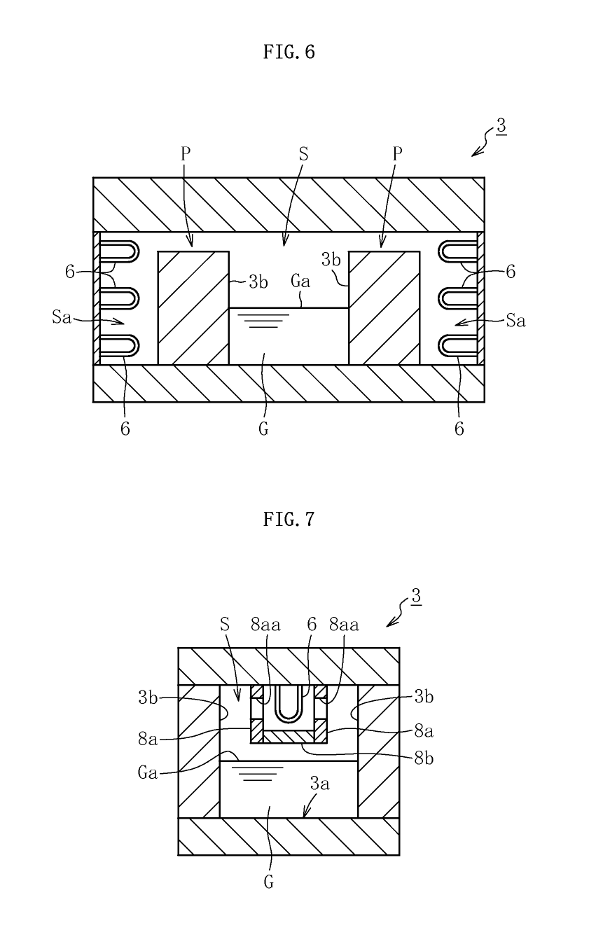

FIG. 6 is a vertical cross-sectional front cross-section for illustrating a feeder according to a seventh embodiment of the present invention. In the feeder 3, the number and the mounting positions of the electric heating elements are changed from those of the feeder according to the above-mentioned third embodiment.

As illustrated in FIG. 6, in the feeder 3 according to the seventh embodiment, the mounting positions of the electric heating elements 6 are changed from the upper portions of the inner peripheral wall of the feeder 3 to side walls surrounding the extended spaces Sa. Further, the number of the electric heating elements is changed from one pair (two electric heating elements) to three pairs (six electric heating elements). Assuming that a pair of electric heating elements 6 is one set, three sets of the electric heating elements 6 are arranged in the extended space Sa in a vertical direction at equal intervals.

Also in the feeder 3 according to the seventh embodiment, similar effects as those of the feeder according to the above-mentioned first embodiment and the feeder according to the above-mentioned third embodiment can be provided. Further, the feeder 3 according to the seventh embodiment is similar to the feeder according to the third embodiment in the heat transfer path in which the heat from the electric heating elements 6 is transferred to the molten glass G, and in the side portions 3b of the inner peripheral wall of the feeder 3 serving as the restricting portions (plate-like members).

FIG. 7 is a vertical cross-sectional front view for illustrating a feeder according to an eighth embodiment of the present invention. The feeder 3 according to the eighth embodiment is different from the feeder according to the above-mentioned first embodiment in that the refractory plates 7 are removed, that the number of the electric heating elements 6 is only one, and that the electric heating element 6 is surrounded by plate members 8a and a plate member 8b.

The electric heating element 6 is mounted to the upper portion of the inner peripheral wall of the feeder 3 in the center in the width direction, and a plurality of the electric heating elements 6 are arranged along the flowing direction of the molten glass G at equal intervals. Both the plate members 8a and 8b are formed of a refractory. The plate member 8b is arranged below the electric heating element 6 and extends horizontally in the width direction along the bottom portion 3a of the inner peripheral wall of the feeder 3 and the surface Ga of the molten glass. A pair of plate members 8a are arranged at symmetrical positions across the electric heating element 6 and the plate member 8b in the width direction, and an opening portion 8aa is formed through each of the pair of plate members 8a. Further, the heat is restricted from being directly transferred to the molten glass G by both the plate members 8a and 8b in the heat transfer path in which the heat from the electric heating element 6 reaches the surface Ga of the molten glass. Specifically, in this embodiment, both the plate members 8a and 8b serve as the restricting portions (plate-like members).

Also in the feeder 3 according to the eighth embodiment, similar effects as those of the feeder according to the above-mentioned first embodiment can be provided. Note that, in the eighth embodiment, the heat is reliably restricted from being directly transferred to the molten glass G by both the plate members 8a and 8b. The heat from the electric heating element 6 is transferred to the molten glass G through a heat transfer path in which the heat bypasses the plate member 8b and passes through the opening portions 8aa formed in the plate members 8a to reach the surface Ga of the molten glass, and through a heat transfer path in which the heat from the electric heating elements 6 heats both the plate members 8a and 8b and then the heat from both the plate members 8a and 8b reaches the surface Ga of the molten glass.

Further, in the eighth embodiment, even when a part of the electric heating element 6 is fractured due to the corrosion of the electric heating element 6 and the like, the electric heating element 6 is surrounded by both the plate members 8a and 8b, and hence the fractured portion becomes less liable to fall on the molten glass G. As a result, there is an advantage in that the generation of a defect is avoided in the glass fibers F manufactured of the molten glass G.

Note that, the feeder according to the present invention is not limited to the configurations described in the above-mentioned respective embodiments. For example, in the above-mentioned respective embodiments, the feeder supplies the molten glass to the bushings configured to form the glass fibers. However, for example, the feeder according to the present invention may be used also in the case of supplying the molten glass to a forming trough configured to form a glass article such as a glass sheet.

Further, in the above-mentioned respective embodiments, the shape of the feeder in horizontal cross-section is a rectangular shape. However, for example, the feeder may have another shape such as a circular shape in horizontal cross-section. Moreover, the number of electric heating elements arranged in the internal space (including the extended space) is not limited to the number described in the above-mentioned respective embodiments, and may be increased or decreased as appropriate. Further, the mounting positions of the electric heating elements are not even limited to the mounting positions described in the above-mentioned respective embodiments. However, when a plurality of the electric heating elements are arranged, it is preferred that the mounting positions of the electric heating elements be symmetrical with respect to the center of the internal space of the feeder in the width direction.

Moreover, in the above-mentioned respective embodiments, the refractory plates, the bank portions, the side portions of the inner peripheral wall of the feeder, and the plate members surrounding the electric heating elements each serve as the restricting portions. However, other configurations may also be employed. The configurations only need to be capable of securing the heat transfer path in which the heat from the electric heating elements bypasses the restricting portions to reach the surface of the molten glass, and the heat transfer path in which the heat from the electric heating elements heats the restricting portions and then the heat from the restricting portions reaches the surface of the molten glass.

### REFERENCE SIGNS LIST

1 glass fiber forming apparatus
2 melting furnace
2a feed port
3 feeder
3a bottom portion
3b side portion
3c bank portion
4 glass raw material
5 bushing
6 electric heating element
7 refractory plate
8a plate member
8aa opening portion
8b plate member
G molten glass
Ga surface of molten glass
F glass fiber
P
S internal space of feeder
Sa extended space
C recessed portion

1. A feeder configured such that molten glass is caused to flow through an inside of the feeder, the feeder comprising:
electric heating elements arranged in an internal space of the feeder along a flowing direction of the molten glass, which are configured to heat the molten glass; and
restricting portions provided in a heat transfer path in which heat from the electric heating elements reaches a surface of the molten glass, which are configured to restrict the heat from being directly transferred to the molten glass.

2. The feeder according to claim 1, wherein the restricting portions comprise plate-like members interposed between the electric heating elements and the surface of the molten glass.

3. The feeder according to claim 2,
wherein the electric heating elements are arranged on lateral sides in the internal space of the feeder in a width direction of the internal space, and
wherein the plate-like members extend from side portions of an inner peripheral wall of the feeder toward a center in the width direction of the internal space along a bottom portion of the inner peripheral wall of the feeder.

4. The feeder according to claim 1, further comprising bushings provided in the bottom portion of the inner peripheral wall of the feeder, which are configured to form the molten glass into glass fibers.
